(19) United States
(12) Patent Application Publication
(10) Pub. No.: US 2024/0193928 A1
(43) Pub. Date: Jun. 13, 2024

(54) ADAPTATION OF NEURAL NETWORKS TO NEW OPERATING SITUATIONS

(71) Applicant: Robert Bosch GmbH, Stuttgart (DE)

(72) Inventor: Jan Hendrik Metzen, Boeblingen (DE)

(21) Appl. No.: 18/527,143

(22) Filed: Dec. 1, 2023

(30) Foreign Application Priority Data
Dec. 9, 2022 (DE) 10 2022 213 384.6

(51) Int. Cl. G06V 10/82; G06V 10/776

(52) U.S. Cl. CPC G06V 10/82; G06V 10/776

(57) ABSTRACT

A method for adapting a neural network for processing measurement data, which network has been trained on training examples, and whose behavior is characterized by a parameter vector, to a new record of measurement data. In the method: a working space for low-dimensional representations of parameter vectors and an image which assigns to each low-dimensional representation a parameter vector are provided; in the working space, candidate representations are set up; the candidate representations are translated using the image into candidate parameter vectors; for each candidate parameter vector, a predetermined quality function is evaluated, which depends on the output of the neural network for the record in the state in which the candidate parameter vector has replaced the original parameter vector; a candidate parameter vector, for which the quality function assumes the best value, is evaluated as the optimal adaptation of the parameters of the neural network to the record.

### CROSS REFERENCE

The present application claims the benefit under 35 U.S.C. § 119 of German Patent Application No. DE 10 2022 213 384.6 filed on Dec. 9, 2022, which is expressly incorporated herein by reference in its entirety.

### FIELD

The present invention relates to the evaluation of measurement data, such as image data, using neural networks.

### BACKGROUND INFORMATION

For the automated guidance of a vehicle or robot in traffic, it is indispensable that the vehicle or the robot semantically captures the corresponding traffic situation correctly, and performs a reaction appropriate to this situation. For this purpose, the surroundings of the vehicle or of the robot are continuously monitored with one or more sensors. The recorded sensor data are often evaluated using neural networks, since these have the ability to generate situations not seen in training. This simulates the ability of human drivers, for example, to drive a vehicle in winter even if all driving lessons during driving training were taken in the summer.

The ability to generalize is tied to the fact that new measurement data at least still belong to the same domain or distribution to which the training data used for the training of the neural network also belong.

### SUMMARY

The present invention provides a method for adapting a neural network f_{θ} for processing measurement data, which network has been trained on training examples of a source domain and/or source distribution and whose behavior is characterized by a parameter vector θ, to a new record xₜ of measurement data.

Here, the term “record” denotes a data set of associated data, comparable to the information on a card in a card index box. A record can be, for example, values of a plurality of measured variables which jointly characterize an operating state of a technical system, or even be image data and possibly associated metadata. Here, the term “record” is used instead of “data set,” since the term “data set” has already been taken over in the technical language of machine learning and designates the collection of all records, comparable to the card index box that contains all index cards.

The measurement data can in particular be, for example, image data, such as camera images, video images, radar images, lidar images, thermal images or ultrasound images. The parameter vector θ can in particular contain, for example, weightings with which inputs that are supplied to a neuron of the neural network are summed up in order to activate this neuron.

The new record xₜ of measurement data can in particular belong to a target domain and/or target distribution which is not identical to the source domain and/or source distribution, but can partially overlap therewith.

A subsequent adaptation of the parameter vector θ of a neural network f_{θ} has previously been performed either
off-line with a large quantity of new records xₜ of measurement data at one time, or
on-line with a continuous data stream of new records xₜ. What the two alternatives have in common is that the adaptation to a determined target domain or target distribution of measurement data can only be obtained against payment of a “price” in the form of a large number of records x, from this target domain or target distribution. The only choice is whether to pay this “price” in a single sum or in installments via the data stream.

In contrast, the aim of the method according to the present invention is to make a reasonable adaptation of the parameter vector θ of a neural network f_{θ} to a single record xₜ of measurement data, without being dependent on the fact that there are still further records xₜ from the same domain or distribution.

Ascertaining changes in a very large number of parameters in a parameter vector θ directly from a small number of measured values in a single record xₜ is mathematically speaking a “poorly posed problem,” because at least Hadamard's requirement that the solution be uniquely determined is not fulfilled. This is comparable to the solution of an underdetermined linear equation system in which there are essentially more unknowns than equations.

For this reason, within the scope of the method of the present invention, a working space ψ for low-dimensional representations δ of parameter vectors θ and an image h which assigns to each low-dimensional representation δ a parameter vector θ are provided. The search for the adapted parameter vector θ is thus taken back to the search in the working space ψ for a low-dimensional representation δ, the image of which h(δ)=: θ achieves what is desired. The task is thereby substantially simplified. For example, a neural network that is intended to process a 256×256 pixel-sized image with 3 color channels will receive 256×256×3=196 608 numbers as input and requires, per neuron in the input layer, just as many weightings that decide how these numbers are to be summed up in each case in order to activate the neuron. In the entire network, several million weightings are quickly combined here. The working space ψ can, on the other hand, have a dimensionality between 10 and 100, i.e., only 10 to 100 numbers have to be found in order to ascertain the representation δ and thus ultimately the parameter vector h(δ)=: θ.

However, it is not necessary for each component of a low-dimensional representation δ in the working space ψ to act via the image h on all components of the parameter vector θ. It is rather the case that, for example, even the portion of the parameter vector θ which relates to a deeper layer in a convolutional neural network f can also be regarded as a low-dimensional representation δ of this parameter vector θ.

For this purpose, according to an example embodiment of the present invention, candidate representations δ_{c}, which can originate from any source, are set up in the working space ψ. The candidate representations δ_{c} can, for example, be iteratively ascertained using an optimization method of any kind as well as an optimized optimization method or can also be randomly sampled from the working space ψ. The working space ψ can also, for example, be searched systematically in a grid for candidate representations δ_{c}.

According to an example embodiment of the present invention, the candidate representations δ_{c} are translated using the image h into candidate parameter vectors θ_{c}. That is to say, at least the image h(δ_{c}) is ascertained. This image h(δ_{c}) can be used directly as a candidate parameter vector θ_{c}. However, it can also be further processed in any suitable manner in order to obtain the candidate parameter vector θ_{c}. The final candidate parameter vector θ_{c} is thus obtained from a function which depends in any way on the image h(8° C.).

For each candidate parameter vector θ, a predetermined quality function [symbol] (f_{θ}_{_{c}}(xₜ)) is evaluated. This quality function [symbol] (f_{θ}_{_{c}}(xₜ)) depends on the output of the neural network f for the record xₜ in the state in which the candidate parameter vector θ_{c} has replaced the original parameter vector θ.

According to an example embodiment of the present, the quality function can, for example, measure an entropy of the output f_{θ}_{_{c}}(xₜ)) of the neural network f adapted with the parameters θ_{c}. The lower this entropy is, the more the output vector f_{θ}_{_{c}}(xₜ) will differ from a vector with randomly distributed values, and the more plausible it will be that this vector is a genuine result derived from the measurement data xₜ. In a neural network f used as a classifier, the output vector f_{θ}_{_{c}}(xₜ) can be for example a softmax vector of the classification scores ascertained for the new record x, in relation to one or more classes. However, the quality function can also be a trainable function which, for example, can be trained on validation examples labeled with target outputs.

According to an example embodiment of the present invention, a candidate parameter vector θ_{c}, for which the quality function [symbol] (f_{θ}_{_{c}}(xₜ)) assumes the best value, is evaluated as the optimal adaptation θ(xₜ) of the parameters θ of the neural network f to the record xₜ. The output f_{θ}(xₜ)(xₜ) of the neural network f parametrized with the adapted parameter vector θ(xₜ) is depending on the distance of the record xₜ from the source domain or source distribution of the original training data—in the context of the corresponding application with a high probability more accurate for the record xₜ than the output f_{θ}(xₜ) of the non-adapted neural network f.

The adaptation undertaken with the method according to the present invention thus has the effect in particular that the neural network f provides more accurate results for new records xₜ of measurement data that are located at the edge of the source domain or source distribution or even outside this source domain or source distribution. Neither a large collection of new records xₜ nor access to the training examples used for training the neural network f is necessary. The method can thus be carried out during ongoing operation of the neural network f at the end user, for example in a control device of a vehicle. As a rule, the end user is not given access to the training examples, since these are essential operating capital of the manufacturer of the control device (or of the software running thereon) and issuing image data in particular to a group of recipients that can no longer be limited can also be problematic under data protection legislation. Even if there were to be access to the training examples, their use would hardly be manageable in the limited memory and with the limited computing resources of a control device.

In a particularly advantageous embodiment of the present invention, the candidate representations d, in the working space V are iteratively optimized for an improvement in the value supplied by the quality function [symbol] (f_{θ}_{_{c}}(xₜ)) after translation into a candidate parameter vector θ_{c}. In this way, the feedback provided by the quality function [symbol] (f_{θ}_{_{c}}(xₜ)) is used continuously. It is to be expected that optima in the working space are not singularities arising “out of nowhere,” but rather the value landscape spanned by the quality function [symbol] (f_{θ}_{_{c}}(xₜ)) approaches in some form the optima.

In particular, the candidate representation δ_{c} can, for example, be changed at each iteration in the direction of a gradient of the quality function [symbol] (f_{θ}_{_{c}}(xₜ)) following the candidate representation &c. If this gradient exists, the feedback of the quality function [symbol] (f_{θ}_{_{c}}(xₜ) can thus be used particularly effectively. For example, the iteration δ_{c,i+1} of the candidate representation ô, according to the requirement

$${δ}_{c , i + 1} = {δ}_{c , i} - {α}_{i} {∇}_{{δ}_{c , i}} ℒ ( {f}_{{θ}_{c}} ( {x}_{t} ) )$$

can be ascertained from the previous iteration dci. Here, ai is a learning rate that can be adapted to the progress of optimization.

In a further particularly advantageous embodiment of the present invention, the translation of the candidate representations δ_{c} into candidate parameter vectors θ_{c} includes adding the original parameter vector θ to the result h(δ_{c}) of the image h. In this way, a specific search is made for a modification of the parameter vector θ in the sense that an improvement is achieved without calling into question the result of previous training.

As image h, in particular, for example, a linear image h (δ_{c})=Wδ_{c}+b with a matrix W and a vector b can be selected. The behavior of such a linear image is characterized by parameters which can in their turn be optimized. The image h thus becomes accessible to “meta-learning.”

However, a multilayer perceptron can also be selected as image h. In this way, even more complex relationships can be mapped. Such a multilayer perceptron is also accessible to “meta-learning.”

In a further particularly advantageous embodiment of the present invention, training examples xₘ are provided from a training domain and/or training distribution different from the source domain and/or source distribution. These training examples xₘ are labeled with target outputs yₘ into which the neural network f is to translate them. The image h is optimized such that the γneural network f, with the parameters θ(xₘ) adapted to the respective training example xₘ with this image h being used, reproduces the target outputs yₘ as well as possible. In particular, for example, the monitored cost function (loss function) already used for previous training can be further used as feedback for this optimization. In this way, the image h can be “meta-learned”. Significantly fewer training examples are required for this than for a complete new training of the neural network f in the training domain. Only the specific adaptation to the training domain has to be learned, while the originally trained capability of the neural network f with regard to a predetermined task is used further. The term “meta-learning” embodies, in particular, the fact that another level is added to optimization; parameters characterizing the behavior of the image h are optimized. For the assessment as to whether a determined state of these parameters is good or rather not, the adaptation to the record xₜ in question must in each case be completed.

By means of meta-learning with one or more training domains or training distributions, in particular the choice of the working space ψ and the choice of the image h can be optimized such that this working space ψ and this image h are then also suitable for coping with many further domain shifts.

For meta-learning, such training examples xₘ can in particular be used whose domain shift goes qualitatively in a similar direction to the domain shifts to be expected in the subsequent effective operation of the neural network f in the case of the records xₜ then arising. That there are enough of such training examples xₘ is then more important than whether the domain shifts to be expected are effected exactly. For example, synthetically generated training examples can be used, for which no manual effort is required for labeling with target outputs yₘ, since these target outputs yₘ are known from the outset.

In a further particularly advantageous embodiment of the present invention, the adaptation of the parameter vector θ is additionally controlled as a function of a history of the original training of the neural network f. In this case, for example, the adaptation of determined portions of the parameter vector θ can in particular be preferred or deferred in comparison to the adaptation of other portions. The history of the original training provides, in particular, information about which parameters have already remained stable in their final state for a long time during training, and which parameters have significantly changed even during the last periods of the training.

Advantageously, parameters in the parameter vector θ will thus be adapted to a greater extent the more they have changed within a predetermined horizon of periods before completion of the original training. With these parameters, the need for adaptation is most likely to be expected for new records xₜ of measurement data outside the original source domain or source distribution.

In a further particularly advantageous embodiment of the present invention, in response to the determination that a steepness with which the quality function [symbol] (f_{θ}_{_{c}}(xₜ)) approaches an optimum exceeds a predetermined threshold value, this optimum is disregarded, and/or a new working space ψ for low-dimensional representations δ is established. This means that the optimum is no longer sought, but instead a further search is made for another optimum, possibly even in a completely different working space Y. If the quality function runs too steeply towards the optimum, this will be an indication that the currently selected working space ψ thus fits so particularly well to the domain shift embodied in the current record xₜ that it overfits this domain shift. This is to be compared figuratively to the fact that, in the landscape of the workspaces ψ in which a minimum is sought with regard to a determined target function, there are well shafts in addition to mountains and sought valleys. Anyone who steps in there will get down even deeper in the landscape even faster as a result, but will have no benefit from it. The monitoring of steepness masks out these “well shafts” and focuses the search for the genuine lowlands being sought.

The measurement data can in particular be measurement data which have been obtained by monitoring the surroundings of a vehicle and/or robot by means of at least one sensor. Especially in the public traffic space, there are often domain shifts which the entity that originally trained the neural network f does not have under control. For example, vehicle manufacturers are always striving to have their new vehicle models visually stand out markedly from previous models. This promotes sales of the new vehicle models, but is counterproductive for the recognition of these vehicles by automatic image classifiers. Likewise, the appearance of pedestrians can also be modified by the new occurrence of fashion trends such as hoodies, leggings or shoulder pads that were not current at the time of training of the neural network f such that their recognition could be impaired by an image classifier. Even enclosures and roadway boundaries made of wire baskets filled with stones can also be new compared to the types of boundaries seen during training and not be recognized as solid obstacles. Surprises in this regard can occur in particular if a vehicle has been trained for a specific market (for example Western and Central Europe) and then a journey into a country in another market (such as southeastern Europe or North Africa) is undertaken with this vehicle.

In a further particularly advantageous embodiment of the present invention, a control signal is ascertained from the output f_{θ}(xₜ)(xₜ) of the neural network f adapted to the record xₜ of measurement data. This control signal controls a vehicle, a robot, a driver assistance system, a quality control system, a system for monitoring areas, and/or a system for medical imaging. By adapting the neural network f to the new record xₜ of measurement data, the probability is increased that the reaction performed by the respective controlled technical system in response to the control signal is appropriate to the situation described by the record xₜ of measurement data.

Adaptation to current records xₜ of measurement data can remain constantly active in the effective operation of the neural network f. In this way, the parameter vector θ of the neural network f can also be corrected, for example, for longer-term drifts in the sensor system used for capturing the measurement data. For example, a camera assembly can become misaligned or dirty over time.

The methods described here can be fully or partially computer-implemented and thus embodied in software. The present invention therefore also relates to one or more computer programs comprising machine-readable instructions that, when executed on one or more computers and/or compute instances, cause the computer (s) and/or compute instance (s) to execute the described method. In this sense, control devices for vehicles and embedded systems for technical devices, which are also capable of executing machine-readable instructions, are to be regarded as computers. Compute instances can be virtual machines, containers or serverless execution environments, for example, which can be provided in a cloud in particular.

The present invention also relates to a machine-readable data carrier and/or a download product comprising the one or more computer programs. A download product is a digital product that can be transmitted via a data network, i.e. downloadable by a user of the data network, and which can be supplied for immediate downloading in an on-line store for example.

Furthermore, one or more computers and/or compute instances can be equipped with the one or more computer programs, with the machine-readable data carrier or with the download product.

Further measures improving the present invention are explained in more detail below, together with the description of the preferred embodiments of the present invention, with reference to figures.

### BRIEF DESCRIPTION OF THE DRAWINGS

FIG. 1 shows an exemplary embodiment of the method 100 for adapting a neural network f_{θ} to a new record xₜ of measurement data, according the present invention.

FIG. 2 illustrates the optimization of the parameter vector θ(xₜ) via low-dimensional candidate representations δ_{c}, according to an example embodiment of the present invention.

FIG. 3 illustrates the monitored meta-learning of the workspace ψ and of the image h according to steps 113 and 114 of the method 100, according to an example embodiment of the present invention.

### DETAILED DESCRIPTION OF EXAMPLE EMBODIMENTS

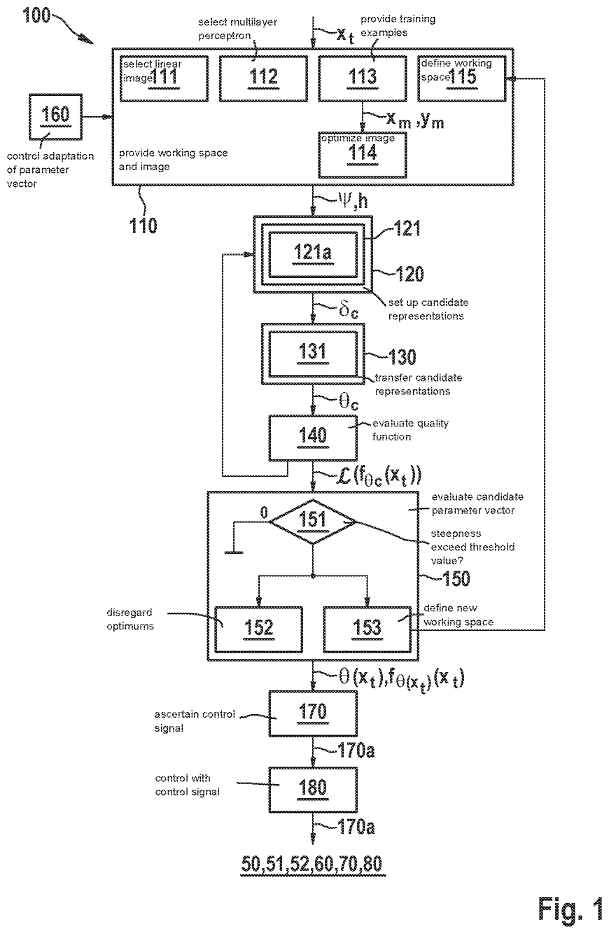

FIG. 1 is a schematic flowchart of an exemplary embodiment of the method 100 for adapting a neural network f_{θ} trained on training examples of a source domain and/or source distribution for processing measurement data. The behavior of this neural network f_{θ} is characterized by a parameter vector θ.

In step 110, a working space ψ for low-dimensional representations d of parameter vectors θ and an image h which assigns to each low-dimensional representation δ a parameter vector θ are provided.

According to block 111, a linear image h(δ_{c})=Wδ_{c}+b with a matrix W and a vector b can be selected.

According to block 112, a multilayer perceptron can be selected as image h.

According to block 113, training examples xₘ can be provided from a training domain and/or training distribution different from the source domain and/or source distribution. These training examples xₘ are labeled with target outputs yₘ into which the neural network f is to translate them. According to block 114, the image h can then be optimized so that the neural network f reproduces as well as possible the target outputs yₘ with the parameters θ(xₘ) adapted to the respective training example xₘ, with this image h being used.

In step 120, candidate representations δ_{c} are set up in the working space ψ.

According to block 121, the candidate representations δ_{c} in the working space ψ are iteratively optimized for an improvement in the value supplied after translation into a candidate parameter vector θ, by the quality function [symbol] (f_{θ}_{_{c}}(xₜ)).

In this case, according to block 121a, the candidate representation δ_{c} can be changed at each iteration in the direction of a gradient of the quality function [symbol] (f_{θ}_{_{c}}(xₜ)) following the candidate representation δ_{c}.

In step 130, the candidate representations δ_{c} are translated using the image h into candidate parameter vectors θ_{c}.

According to block 131, this translation of the candidate representations δ_{c} into candidate parameter vectors θ_{c} includes adding the original parameter vector θ to the result h(δ_{c}) of the image h.

In step 140, for each candidate parameter vector θ_{c}, a predetermined quality function [symbol] (f_{θ}_{_{c}}(xₜ)) is evaluated, which depends on the output of the neural network f for the record xₜ in the state in which the candidate parameter vector θ, has replaced the original parameter vector θ.

In step 150, a candidate parameter vector θ_{c}, for which the quality function [symbol] (f_{θ}_{_{c}}(xₜ)) assumes the best value, is evaluated as optimal adaptation θ(xₜ) of the parameters θ of the neural network f to the record xₜ.

According to block 151, it can be checked whether a steepness with which the quality function [symbol] (f_{θ}_{_{c}}(xₜ)) approaches an optimum exceeds a predetermined threshold value. If this is the case (truth value 1),
according to block 152, these optimums can be disregarded, and/or
according to blocks 153 and 115, a new working space ψ for low-dimensional representations δ can be defined, which is then also accompanied by the establishment of a new image h.

In step 160, the adaptation of the parameter vector θ can additionally be controlled as a function of a history of the original training of the neural network f. This can in particular be based on the establishment of the working space ψ and of the image h, since in particular the image h decides how the low-dimensional representations δ from the working space ψ will ultimately act on the parameter vector θ.

In step 170, a control signal (170a) is ascertained from the output f_{θ}(xₜ)(xₜ) of the neural network f adapted to the record xₜ of measurement data.

In step 180, a vehicle 50, a robot 51, a driver assistance system 52, a system 60 for quality control, a system 70 for monitoring areas, and/or a system 80 for medical imaging, is controlled with this control signal 170a.

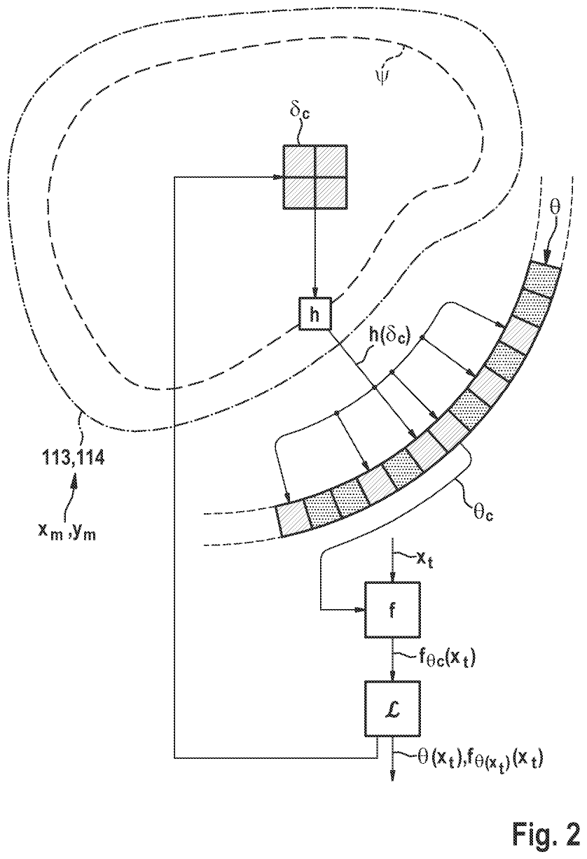

FIG. 2 illustrates how a search for low-dimensional candidate representations δ_{c} can significantly simplify the search for an optimal parameter vector θ(xₜ) for the adaptation of the neural network f to the new record xₜ of measurement data.

The candidate representations δ_{c} have much fewer components than the parameter vector θ, so that the search for an optimum is considerably simpler. The image h translates each candidate representation δ_{c} into an image h(δ_{c}) in the space of the parameter vectors θ. The original parameter vector θ is then also added to this. In the example shown in FIG. 2, only some of the parameters in the original parameter vector θ are modified on the basis of the image h(δ_{c}). A candidate parameter vector θ_{c} is created.

The neural network f is parametrized with this candidate parameter vector θc, and the record xₜ of measurement data to which the network f is to be adapted is processed by the network f to an output f_{(θ}_{_{c}}₎₍ₓ_{ₜ}₎. This output f_{(θ}_{_{c}}₎₍ₓ_{ₜ}₎ is evaluated with the quality function £ without recourse to target outputs (also referred to as “ground truth labels”). This evaluation serves as feedback for the search for the optimal candidate representation δ_{c}. If it was determined on the basis of any termination criterion that the optimization has converged, the candidate parameter vector θ_{c} then present will be the sought adaptation θ(xₜ) of the parameters θ of the neural network f to the record xₜ.

This adaptation θ(xₜ) can then also be used directly to parametrize the neural network f therewith. The output f_{θ(x}_{ₜ}₎₍ₓ_{ₜ}₎ thus generated from the record xₜ is more precise with regard to the present application than the output f_{θ(x}_{ₜ}₎ obtained without adaptation, i.e. on the basis of the original parameter vector θ.

In steps 113 and 114 of the method 100 the working space ψ and the image h are meta-learned on the basis of training examples xₘ labeled with target outputs yₘ.

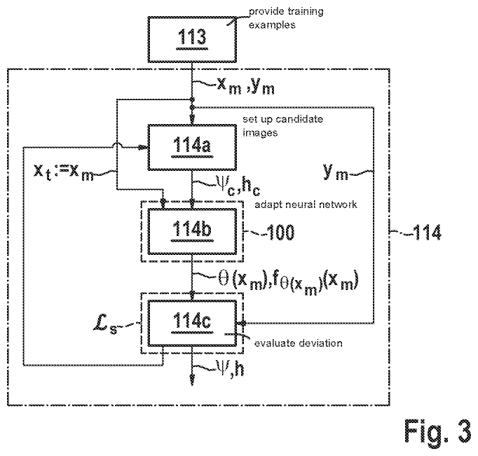

FIG. 3 illustrates this monitored meta-learning. For this purpose, the optimization of the image h is further subdivided in accordance with step 114.

According to block 114a, candidate images h_{c} are set up which correspond to candidate workspaces ψ_{c}. For this purpose, in particular, for example, parameters of any parametrized approach for the image h can be varied.

According to block 114b, using the method 100, the neural network f is adapted in each case to the training examples xₘ as new records xₜ. As explained above, this results in an adaptation θ(xₘ) of the parameter vector θ, and with this adaptation θ(xₘ) the neural network f processes the training example xₘ into an output f_{θ(x}_{ₘ}₎₍ₓ_{ₘ}₎.

A deviation of this output f_{θ(x}_{ₘ}₎₍ₓ_{ₘ}₎ from the target output belonging to the corresponding training example xₘ is according to block 114c evaluated with the monitored cost function Ls. This evaluation serves as feedback for setting up new candidate images h_{c}. If the optimization is terminated according to a predetermined termination criterion, the candidate images h_{c} then present will be defined as the final image h, which then also defines the working space ψ.

What is claimed is:

1. A method for adapting a neural network for processing measurement data, which network has been trained on training examples in a source domain and/or source distribution and whose behavior is characterized by a parameter vector, to a new record of measurement data, the method comprising the following steps:
providing a working space for low-dimensional representations of parameter vectors, and an image which assigns to each low-dimensional representation a parameter vector;
setting up, in the working space, candidate representations;
translating the candidate representations, using the image, into candidate parameter vectors;
for each candidate parameter vector, evaluating a predetermined quality function, which depends on an output of the neural network for the record in a state in which the candidate parameter vector has replaced an original parameter vector of the parameter vectors;
evaluating a candidate parameter vector, for which the quality function assumes the best value, as an optimal adaptation of parameters of the neural network to the record.

2. The method according to claim 1, wherein the candidate representations in the working space are iteratively optimized for an improvement in a value supplied after translation into a candidate parameter vector by the quality function.

3. The method according to claim 2, wherein the candidate representation is changed at each iteration in a direction of a gradient of the quality function following the candidate representation.

4. The method according to claim 1, wherein the translation of the candidate representations into the candidate parameter vectors includes adding the original parameter vector to a result of the image.

5. The method according to claim 1, wherein the image is a linear image h(δ_{c})=Wδ_{c}+b with a matrix W and a vector b.

6. The method according to claim 1, wherein the image is a multilayer perceptron.

7. The method according to claim 1, wherein:
training examples are provided from a training domain and/or training distribution different from the source domain and/or source distribution, wherein the training examples are labeled with target outputs into which the neural network is to translate them; and
the image is optimized such that the neural network reproduces as well as possible the target outputs with the parameters adapted to the respective training example, with the image being used.

8. The method according to claim 1, wherein the adaptation of the parameter vector is additionally controlled as a function of a history of an original training of the neural network.

9. The method according to claim 8, wherein parameters in the parameter vector are adapted to a greater extent the more they have changed in a predetermined horizon of periods before completion of the original training.

10. The method according to claim 1, wherein in response to a determination that a steepness with which the quality function approaches an optimum exceeds a predetermined threshold value, the optimum is disregarded, and/or a new working space for low-dimensional representations is established.

11. The method according to claim 1, wherein the measurement data is measurement data which have been obtained by monitoring surroundings of a vehicle and/or robot using at least one sensor.

12. The method according to claim 1, further comprising:
ascertaining a control signal from output of the neural network adapted to the record of the measurement data, and
controlling, using the control signal: a vehicle, and/or a robot, and/or a driver assistance system, and/or a quality control system, and/or a system for monitoring areas, and/or a system for medical imaging.

13. A non-transitory machine-readable data carrier on which is stored one or more computer programs including machine-readable instructions for adapting a neural network for processing measurement data, which network has been trained on training examples in a source domain and/or source distribution and whose behavior is characterized by a parameter vector, to a new record of measurement data, the instructions, when executed one or more computers and/or compute instances, cause the one or more computers and/or compute instances to perform the following steps:
providing a working space for low-dimensional representations of parameter vectors, and an image which assigns to each low-dimensional representation a parameter vector;
setting up, in the working space, candidate representations;
translating the candidate representations, using the image, into candidate parameter vectors;
for each candidate parameter vector, evaluating a predetermined quality function, which depends on an output of the neural network for the record in a state in which the candidate parameter vector has replaced an original parameter vector of the parameter vectors; and
evaluating a candidate parameter vector, for which the quality function assumes the best value, as an optimal adaptation of parameters of the neural network.

14. One or more computers and/or compute instances configured to adapt a neural network for processing measurement data, which network has been trained on training examples in a source domain and/or source distribution and whose behavior is characterized by a parameter vector, to a new record of measurement data, the one or more computers and/or compute instances configured to:
provide a working space for low-dimensional representations of parameter vectors, and an image which assigns to each low-dimensional representation a parameter vector;
set up, in the working space, candidate representations;
translate the candidate representations, using the image, into candidate parameter vectors;
for each candidate parameter vector, evaluate a predetermined quality function, which depends on an output of the neural network for the record in a state in which the candidate parameter vector has replaced an original parameter vector of the parameter vectors; and
evaluate a candidate parameter vector, for which the quality function assumes the best value, as an optimal adaptation of parameters of the neural network to the record.
